(19) United States
(12) Patent Application Publication
(10) Pub. No.: US 2019/0348855 A1
(43) Pub. Date: Nov. 14, 2019

(54) POWER TRANSMISSION APPARATUS, ELECTRIC POWER TRANSMISSION SYSTEM, AND METHOD FOR CONTROLLING POWER TRANSMISSION APPARATUS

(71) Applicant: FUJITSU LIMITED, Kawasaki-shi (JP)

(72) Inventor: Akiyoshi Uchida, Akashi (JP)

(73) Assignee: FUJITSU LIMITED, Kawasaki-shi (JP)

(21) Appl. No.: 16/524,415

(22) Filed: Jul. 29, 2019

Related U.S. Application Data
(63) Continuation of application No. PCT/JP2017/004869, filed on Feb. 10, 2017.

(51) Int. Cl. H02J 7/02; H02J 50/12; H02J 50/40

(52) U.S. Cl. CPC H02J 7/025; H02J 50/40; H02J 50/12

(57) ABSTRACT

A power transmission apparatus for transmitting electric power to one or more power receivers each including a secondary-side resonant coil, the power transmission apparatus includes: a primary-side resonant coil configured to transmit electric power by magnetic field resonance or electric field resonance; a high-frequency power supply configured to output transmission electric power with high-frequency to the primary-side resonant coil; and a processor configured to control the transmission electric power output from the high-frequency power supply to the primary-side resonant coil and determine whether the one or more power receivers perform a charging operation, based on an impedance of the primary-side resonant coil which is seen from the high-frequency power supply side.

### CROSS-REFERENCE TO RELATED APPLICATION

This application is a continuation application of International Application PCT/JP2017/004869 filed on Feb. 10, 2017 and designated the U.S., the entire contents of which are incorporated herein by reference.

### FIELD

The embodiments relate to a power transmission apparatus, an electric power transmission system, and a method for controlling the power transmission apparatus.

### BACKGROUND

A contactless charging apparatus including a batch charging unit capable of batch charging for a plurality of electronic devices by a contactless charging method is provided.

Related art is disclosed in Japanese Laid-open Patent Publication No. 2011-62361.

### SUMMARY

According to an aspect of the embodiments, a power transmission apparatus for transmitting electric power to one or more power receivers each including a secondary-side resonant coil, the power transmission apparatus includes: a primary-side resonant coil configured to transmit electric power by magnetic field resonance or electric field resonance; a high-frequency power supply configured to output transmission electric power with high-frequency to the primary-side resonant coil; and a processor configured to control the transmission electric power output from the high-frequency power supply to the primary-side resonant coil and determine whether the one or more power receivers perform a charging operation, based on an impedance of the primary-side resonant coil which is seen from the high-frequency power supply side, wherein the electronic power controller is configured to execute a first loop process to be executed after starting power transmission by predetermined transmission electric power, the first loop process includes: a first transmission electric power control process in which the processor decreases the transmission electric power output from the high-frequency power supply by the predetermined electric power; and a first determination process in which the processor determines whether the one or more power receivers perform the charging operation, in a state in which the transmission electric power decreased by the predetermined electric power is transmitted, and the first loop process returns to the first transmission electric power control process by the processor when determining in the first determination process that the one or more power receivers perform the charging operation.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an electric power transmission system.

FIG. 2 is a diagram illustrating a power receiver and a power transmission apparatus according to a first embodiment.

FIG. 3 is a diagram illustrating a configuration of a control unit according to the first embodiment.

FIG. 4 is a flowchart illustrating processes to be executed by the control unit according to the first embodiment.

FIG. 5 is a diagram illustrating an exemplary operation of the power transmission apparatus according to the first embodiment.

FIG. 6 is a diagram illustrating an exemplary operation of the power transmission apparatus in a second loop process according to the first embodiment.

FIG. 7 is a diagram illustrating another exemplary operation of the power transmission apparatus according to the first embodiment.

FIG. 8 is a diagram illustrating still another exemplary operation of the power transmission apparatus according to the first embodiment.

FIG. 9 is a diagram illustrating a control unit of a power transmission apparatus according to a second embodiment.

FIGS. 10A and 10B are a flowchart illustrating processes to be executed by the control unit according to the second embodiment.

### DESCRIPTION OF EMBODIMENTS

For example, a contactless charging apparatus includes an acquisition unit configured to acquire device information on each electronic device; and a determination unit configured to determine whether each of the electronic devices is compatible with the batch charging, based on the device information acquired by the acquisition unit.

The contactless charging apparatus (power transmission apparatus) described above also includes a noncontact communication unit configured to acquire, by wireless communication, device information from each electronic device (power receiver) including a wireless communication unit.

In order to embody a power transmission apparatus with a simpler configuration, a configuration including no communication unit may be considered. It is however difficult for the power transmission apparatus to appropriately transmit electric power without wireless communication with a power receiver.

A power transmission apparatus having a simple configuration, an electric power transmission system, and a method for controlling the power transmission apparatus may be provided.

Exemplary embodiments of a power transmission apparatus, an electric power transmission system, and a method for controlling the power transmission apparatus will be described below.

### First Embodiment

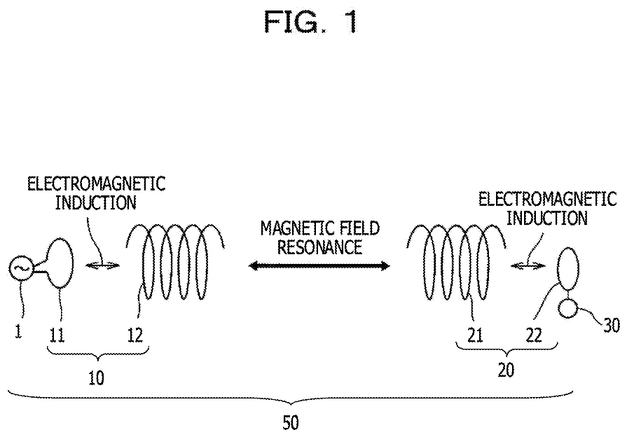

FIG. 1 is a diagram illustrating an electric power transmission system 50.

As illustrated in FIG. 1, the electric power transmission system 50 includes an alternating current (AC) power supply 1, a primary-side (power transmitting-side) power transmitter 10, and a secondary-side (power receiving-side) power receiver 20. The electric power transmission system 50 may include a plurality of power transmitters 10 and a plurality of power receivers 20.

The power transmitter 10 includes a primary-side coil 11 and a primary-side resonant coil 12. The power receiver 20 includes a secondary-side resonant coil 21 and a secondary-side coil 22. A load device 30 is connected to the secondary-side coil 22.

As illustrated in FIG. 1, the power transmitter 10 and the power receiver 20 achieve energy (electric power) transmission from the power transmitter 10 to the power receiver 20 by magnetic field resonance (magnetic field resonance) between the primary-side resonant coil (LC resonator) 12 and the secondary-side resonant coil (LC resonator) 21. The electric power transmission from the primary-side resonant coil 12 to the secondary-side resonant coil 21 may be effected by electric field resonance (electric field resonance) or the like in addition to the magnetic field resonance; however, the following description is mainly given of the magnetic field resonance as an example.

The first embodiment describes, as an example, a case where a frequency of an AC voltage to be output from the AC power supply 1 is 6.78 MHz, and a resonance frequency of each of the primary-side resonant coil 12 and the secondary-side resonant coil 21 is 6.78 MHz. The AC power supply 1 is an example of a high-frequency power supply.

The electric power transmission from the primary-side coil 11 to the primary-side resonant coil 12 is effected by electromagnetic induction. The electric power transmission from the secondary-side resonant coil 21 to the secondary-side coil 22 is also effected by electromagnetic induction.

FIG. 1 illustrates the form of the electric power transmission system 50 including the primary-side coil 11. However, the electric power transmission system 50 does not necessarily include the primary-side coil 11. In this case, the AC power supply 1 may be directly connected to the primary-side resonant coil 12. Likewise, FIG. 1 illustrates the form of the electric power transmission system 50 including the secondary-side coil 22. However, the electric power transmission system 50 does not necessarily include the secondary-side coil 22. In this case, the load device 30 may be directly connected to the secondary-side resonant coil 21.

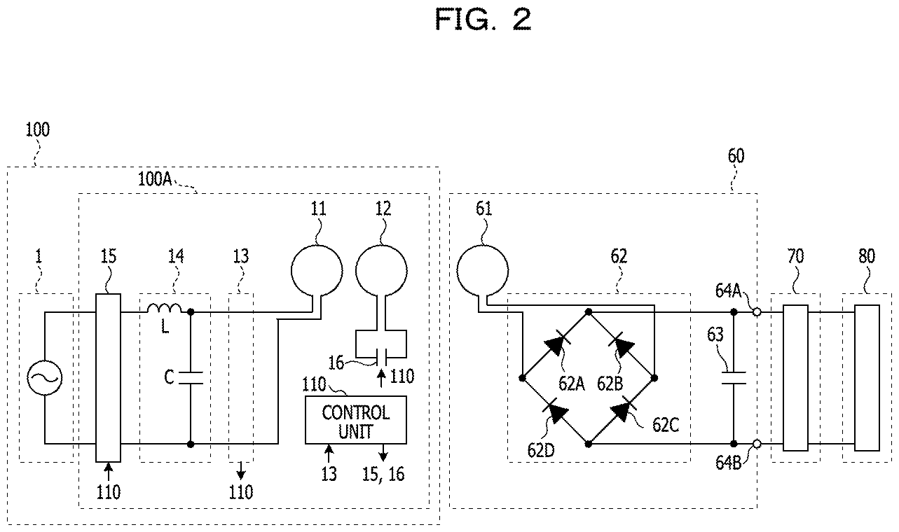

FIG. 2 is a diagram illustrating a power receiver 60 and a power transmission apparatus 100 according to the first embodiment. The power transmission apparatus 100 includes an AC power supply 1 and a power transmitter 100A. The AC power supply 1 is similar to that illustrated in FIG. 1.

The power transmission apparatus 100 includes the AC power supply 1 and the power transmitter 100A. The power transmitter 100A includes a primary-side coil 11, a primary-side resonant coil 12, an impedance detection unit 13, a matching circuit 14, a high-frequency amplifier 15, a capacitor 16, and a control unit 110. The impedance detection unit 13 and the matching circuit 14 may be connected in reverse order.

The power receiver 60 includes a secondary-side resonant coil 61, a rectifier circuit 62, a smoothing capacitor 63, and output terminals 64A and 64B. A direct current to direct current (DC-DC) converter 70 is connected to the output terminals 64A and 64B. A battery 80 is connected to the output side of the DC-DC converter 70. In FIG. 2, a load circuit is the battery 80. The secondary-side resonant coil 61 is equivalent to the secondary-side resonant coil 21 illustrated in FIG. 1. In FIG. 2, the secondary-side resonant coil 61 is directly connected to the rectifier circuit 62 with the secondary-side coil 22 not interposed between the secondary-side resonant coil 61 and the rectifier circuit 62.

First, a description will be given of the power transmitter 100A. As illustrated in FIG. 2, the primary-side coil 11 is a loop-shaped coil, and is connected at its two ends to the AC power supply 1 via the impedance detection unit 13, the matching circuit 14, and the high-frequency amplifier 15. The primary-side coil 11 is disposed in close proximity to the primary-side resonant coil 12 in a noncontact manner, and is electromagnetically coupled to the primary-side resonant coil 12. The primary-side coil 11 is desirably disposed such that its central axis is aligned with the central axis of the primary-side resonant coil 12; however, the central axes are not necessarily aligned with each other. The central axes are aligned with each other for the purpose of improving coupling strength between the primary-side coil 11 and the primary-side resonant coil 12 and suppressing leakage flux to suppress generation of an unnecessary electromagnetic field around the primary-side coil 11 and primary-side resonant coil 12.

The primary-side coil 11 generates a magnetic field from AC electric power supplied from the AC power supply 1 via the impedance detection unit 13, the matching circuit 14, and the high-frequency amplifier 15, and transmits electric power to the primary-side resonant coil 12 by electromagnetic induction (mutual induction).

As illustrated in FIG. 2, the primary-side resonant coil 12 is disposed in close proximity to the primary-side coil 11 in a noncontact manner, and is electromagnetically coupled to the primary-side coil 11. The primary-side resonant coil 12 is designed to have a predetermined resonance frequency, and is designed to have a high quality factor. The resonance frequency of the primary-side resonant coil 12 is set to be equal to a resonance frequency of the secondary-side resonant coil 61. The capacitor 16 for adjusting the resonance frequency is connected in series between the two ends of the primary-side resonant coil 12.

The resonance frequency of the primary-side resonant coil 12 is set to be the same frequency as a frequency of AC electric power to be output from the AC power supply 1. The resonance frequency of the primary-side resonant coil 12 is determined based on an inductance of the primary-side resonant coil 12 and a capacitance of the capacitor 16. Therefore, the inductance of the primary-side resonant coil 12 and the capacitance of the capacitor 16 are set such that the resonance frequency of the primary-side resonant coil 12 is the same frequency as the frequency of the AC electric power to be output from the AC power supply 1.

The impedance detection unit 13 detects a current of transmission electric power supplied from the AC power supply 1 to the primary-side coil 11, thereby detecting an impedance of the primary-side resonant coil 12 seen from the AC power supply 1 side.

In order to detect a change in impedance of the primary-side resonant coil 12, the impedance detection unit 13 detects the impedance of the primary-side resonant coil 12 seen from the AC power supply 1 side. The impedance of the primary-side resonant coil 12 seen from the AC power supply 1 side also includes an impedance of the primary-side coil 11. In the case where the electric power transmission from the primary-side resonant coil 12 to the secondary-side resonant coil 61 is effected by magnetic field resonance, the impedance of the primary-side resonant coil 12 seen from the AC power supply 1 side has an influence on an impedance of the power receiver 60 including the secondary-side resonant coil 61. Therefore, the impedance of the primary-side resonant coil 12 seen from the AC power supply 1 side may be regarded as an impedance on the primary-side resonant coil 12 side seen from the AC power supply 1 side.

The matching circuit 14 is inserted for impedance matching between the primary-side coil 11 and the AC power supply 1, and includes an inductor L and a capacitor C.

The AC power supply 1 is a power supply that outputs AC electric power in a frequency for magnetic field resonance, and incorporates therein an amplifier that amplifies output electric power. The AC power supply 1 outputs AC electric power in a high frequency from about several tens of kilohertz to about several tens of megahertz, for example.

The high-frequency amplifier 15 amplifies electric power (transmission electric power) received from the AC power supply 1, and outputs the amplified electric power to the matching circuit 14. The amplification by the high-frequency amplifier 15 is controlled by the control unit 110.

The capacitor 16 is a capacitor inserted in series between the two ends of the primary-side resonant coil 12. The capacitor 16 is provided for adjusting the resonance frequency of the primary-side resonant coil 12. The capacitor 16 may be a variable displacement capacitor. In this case, the capacitance is set by the control unit 110.

The control unit 110 executes a control process of determining whether the power receiver 60 performs a charging operation, based on an impedance to be detected by the impedance detection unit 13, and decreasing or increasing transmission electric power in accordance with a result of the determination.

The power transmission apparatus 100 described above transmits AC electric power supplied from the AC power supply 1 to the primary-side coil 11, to the primary-side resonant coil 12 by magnetic induction, and transmits the electric power from the primary-side resonant coil 12 to the secondary-side resonant coil 61 of the power receiver 60 by magnetic field resonance. FIG. 2 illustrates the form of one power transmission apparatus 100 that transmits electric power to one power receiver 60. Alternatively, one power transmission apparatus 100 may transmit electric power to a plurality of power receivers 60.

Next, a description will be given of the secondary-side resonant coil 61 in the power receiver 60.

The secondary-side resonant coil 61 is designed to have the same resonance frequency as that of the primary-side resonant coil 12, and is designed to have a high quality factor. The secondary-side resonant coil 61 has a pair of terminals connected to the rectifier circuit 62.

The secondary-side resonant coil 61 outputs, to the rectifier circuit 62, AC electric power transmitted from the primary-side resonant coil 12 of the power transmitter 100A by magnetic field resonance.

The rectifier circuit 62 includes four diodes 62A to 62D. The diodes 62A to 62D are bridge-connected. The diodes 62A to 62D full-wave rectify and output electric power received from the secondary-side resonant coil 61.

The smoothing capacitor 63 is connected to the output side of the rectifier circuit 62. The smoothing capacitor 63 smoothes the electric power full-wave rectified by the rectifier circuit 62, and outputs the smoothed electric power as DC electric power. The output terminals 64A and 64B are connected to the output side of the smoothing capacitor 63. The electric power full-wave rectified by the rectifier circuit 62 is AC electric power of which a negative component is inverted to a positive component, and is therefore treated as substantial AC electric power. However, the use of the smoothing capacitor 63 enables stable DC electric power even in a case where the full-wave rectified electric power contains a ripple.

The DC-DC converter 70 is a step-down DC-DC converter connected to the output terminals 64A and 64B. The DC-DC converter 70 steps down a voltage of DC electric power output from the power receiver 60, to a rated voltage for the battery 80, and outputs the resultant electric power to the battery 80.

The battery 80 may be a rechargeable secondary battery such as a lithium-ion battery. For example, in a case where the power receiver 60 is incorporated in an electronic device such as a tablet computer, a smartphone, or the like, the battery 80 serves as a main battery of such an electronic device.

Each of the primary-side coil 11, the primary-side resonant coil 12, and the secondary-side resonant coil 61 is prepared by winding a copper wire, for example. However, the material for each of the primary-side coil 11, the primary-side resonant coil 12, and the secondary-side resonant coil 61 may be any metal (e.g., gold, aluminum, and the like) in addition to copper. The primary-side coil 11, the primary-side resonant coil 12, and the secondary-side resonant coil 61 may be different in material from one another.

In such a configuration, each of the primary-side coil 11 and the primary-side resonant coil 12 is on the electric power transmission side, and the secondary-side resonant coil 61 is on the electric power reception side.

According to the magnetic field resonance method, electric power transmission from the transmission side to the reception side is effected by magnetic field resonance occurring between the primary-side resonant coil 12 and the secondary-side resonant coil 61. The magnetic field resonance method therefore enables longer-distance electric power transmission as compared with an electromagnetic induction method by which electric power transmission from the transmission side to the reception side is effected by electromagnetic induction.

With regard to a distance or positional deviation between two resonant coils, the magnetic field resonance method is higher in degree of freedom than the electromagnetic induction method, and has a merit of being free of position.

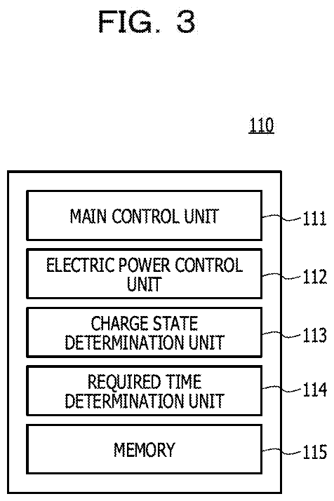

FIG. 3 is a diagram illustrating a configuration of the control unit 110 according to the first embodiment. The control unit 110 includes a main control unit 111, an electric power control unit 112, a charge state determination unit 113, a required time determination unit 114, and a memory 115. The control unit 110 is embodied by, for example, a central processing unit (CPU) chip including a CPU and a memory. The memory of the CPU chip may include at least a nonvolatile memory.

The main control unit 111 is a processing unit that supervises the control by the control unit 110, and executes processes other than processes to be executed by the electric power control unit 112, charge state determination unit 113, and required time determination unit 114. For example, the main control unit 111 supervises a first loop process and a second loop process to be executed for causing the control unit 110 to control transmission electric power. The first loop process and the second loop process will be described later.

The electric power control unit 112 executes a control process of starting power transmission to the power receiver 60, a control process of controlling transmission electric power output from the AC power supply 1 to the primary-side resonant coil 12, and other processes.

In the control process of starting power transmission to the power receiver 60, the electric power control unit 112 starts power transmission at a predetermined initial electric power value of the power transmission apparatus 100. The reason therefor is that the electric power control unit 112 sets the transmission electric power at an optimal value while gradually decreasing the electric power or gradually increasing the electric power in accordance with a result of determination by the charge state determination unit 113.

The electric power control unit 112 executes, as the control processes for controlling the transmission electric power, for example, a first transmission electric power control process, a second transmission electric power control process, a third transmission electric power control process, and a search process.

The first transmission electric power control process is a process in which the electric power control unit 112 decreases transmission electric power output from the AC power supply 1 at a start of the first loop process, by predetermined electric power. The second transmission electric power control process is a process in which, when the charge state determination unit 113 determines that the power receiver 60 does not perform the charging operation, the electric power control unit 112 increases transmission electric power output from the AC power supply 1, to transmission electric power to transmission electric power at the time when the charge state determination unit 113 determines that the power receiver 60 performs the charging operation.

The third transmission electric power control process is a process in which the electric power control unit 112 increases transmission electric power output from the AC power supply 1 when the charge state determination unit 113 determines in a second determination process that the power receiver 60 does not perform the charging operation.

The search process is a process in which the electric power control unit 112 causes the AC power supply 1 to output a beacon signal. The beacon signal is high-frequency electric power in a predetermined short period, and is a signal to be output for searching for the power receiver 60. In the search process, the electric power control unit 112 repeatedly outputs, as a beacon signal, a pulse of transmission electric power at a resonance frequency (6.78 MHz) in a predetermined short period.

The transmission electric power at the time when the charge state determination unit 113 determines that the power receiver 60 performs the charging operation is transmission electric power at the time when the charge state determination unit 113 determined last that the power receiver 60 performs the charging operation, in a control cycle before a current control cycle. A data item on the transmission electric power at the time when the charge state determination unit 113 determines that the power receiver 60 performs the charging operation is stored in the memory 115.

The charge state determination unit 113 monitors a change in impedance of the primary-side resonant coil 12 seen from the AC power supply 1 side, the impedance being detected by the impedance detection unit 13, and determines whether the power receiver 60 performs the charging operation, based on the impedance detected by the impedance detection unit 13.

For example, the charge state determination unit 113 executes a first determination process and the second determination process. The first determination process is a process in which the charge state determination unit 113 determines whether the power receiver 60 performs the charging operation, based on an impedance detected by the impedance detection unit 13, in a state in which transmission electric power output from the AC power supply 1 is decreased by the electric power control unit 112 at a start of the first loop process.

The second determination process is a process in which the charge state determination unit 113 determines whether the power receiver 60 performs the charging operation, based on an impedance detected by the impedance detection unit 13, in the second loop process.

The state in which the power receiver 60 performs the charging operation means a state in which one or more power receivers 60 that receive electric power transmitted from the power transmission apparatus 100 stably charge one or more batteries 80 corresponding thereto. The power receiver 60 includes the step-down DC-DC converter 70. The power receiver 60 steps down a voltage of predetermined reception electric power, and charges the battery 80.

The battery 80 is charged with a minimum amount of electric power for charging. In charging the battery 80, if electric power supplied to the battery 80 is less than a minimum amount of electric power for charging, the battery 80 is not charged. On the other hand, if electric power supplied to the battery 80 is equal to or more than a minimum amount of electric power for charging, the battery 80 is charged.

In order to gain electric power for charging the battery 80 in such a manner that the DC-DC converter 70 steps down the voltage, the power receiver 60 preferably receives a minimum amount of electric power before being subjected to a step-down operation, the electric power corresponding to a minimum amount of electric power for the battery 80.

In a case where electric power received by the power receiver 60 is equal to or more than a minimum amount of electric power, the DC-DC converter 70 is capable of stably and normally performing a step-down operation. Therefore, a switching operation by the DC-DC converter 70 becomes stable. An impedance of the power receiver 60 thus becomes stable, and takes a value within a certain predetermined range. In such a state, an impedance detected by the impedance detection unit 13 also takes a value within a certain predetermined range.

For example, when the impedance detected by the impedance detection unit 13 takes a value within the certain predetermined range, the power receiver 60 stably performs the charging operation.

On the other hand, in a case where electric power received by the power receiver 60 is less than the minimum amount of electric power, the DC-DC converter 70 is incapable of performing a step-down operation. Therefore, a switching operation by the DC-DC converter 70 becomes unstable. An impedance of the power receiver 60 fluctuates largely. In the case where electric power received by the power receiver 60 is less than the minimum amount of electric power, when the DC-DC converter 70 stops, the DC-DC converter 70 is interrupted between the output terminals 64A and 64B and the battery 80. Therefore, the impedance of the power receiver 60 becomes a high impedance (HIZ).

In these states, an impedance detected by the impedance detection unit 13 does not fall within the certain predetermined range described above.

For example, if the impedance detected by the impedance detection unit 13 takes a value out of the certain predetermined range, the power receiver 60 fails to stably perform the charging operation.

In view of this, the charge state determination unit 113 monitors a change in impedance of the primary-side resonant coil 12 seen from the AC power supply 1 side, the impedance being detected by the impedance detection unit 13, and determines whether the power receiver 60 performs the charging operation, based on whether the impedance detected by the impedance detection unit 13 falls within the certain predetermined range.

The required time determination unit 114 executes a required time determination process of determining whether a second required time for the second loop process is equal to or more than a second required time longer than a first required time for the first loop process.

The memory 115 is the memory of the CPU chip that embodies the control unit 110. The memory 115 stores therein programs for execution of the first loop process and second loop process, and data items such as a threshold value and the like.

The memory 115 also stores therein a data item on transmission electric power at the time when the charge state determination unit 113 determines that the power receiver 60 performs the charging operation.

When the charge state determination unit 113 determines that the power receiver 60 performs the charging operation, the memory 115 stores therein only a data item on the transmission electric power at this time. Therefore, a data item on transmission electric power stored in the memory 115 is only a data item on latest transmission electric power among data items on transmission electric power at the time when the charge state determination unit 113 determined in the past that the power receiver 60 performs the charging operation. The memory 115 stores therein only one data item on transmission electric power.

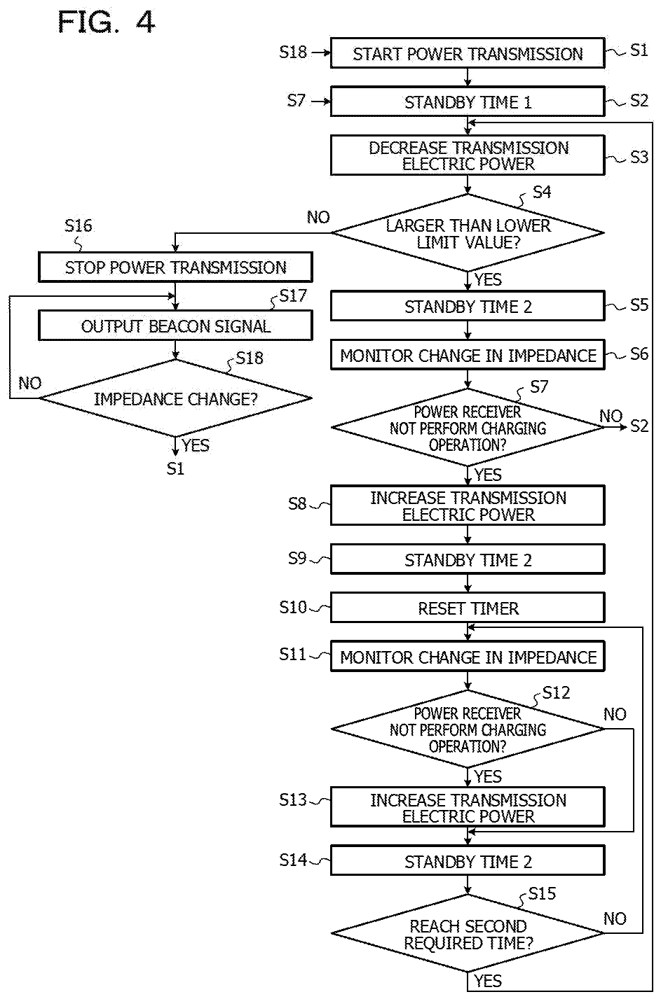

FIG. 4 is a flowchart illustrating the processes to be executed by the control unit 110 according to the first embodiment. The processes illustrated in FIG. 4 are processes to be executed repeatedly by the control unit 110 during a period from turn-on to turn-off of the power transmission apparatus 100.

The processes illustrated in FIG. 4 include two loop processes, that is, the first loop process and the second loop process. The loop process including steps S2, S3, S5, S6, and S7 and returning the flow from step S7 to step S2 is the first loop process. The loop process including steps S11, S12, S13, S14, and S15 and returning the flow from step S15 to step S11 is the second loop process.

When the power transmission apparatus 100 is turned on, first, the electric power control unit 112 starts power transmission (step S1). Transmission electric power at the start of power transmission is set at maximum transmission electric power outputtable from the power transmission apparatus 100.

Next, the main control unit 111 is brought into a standby state for a standby time 1 (step S2). The standby time 1 is, for example, 100 milliseconds.

Next, the electric power control unit 112 decreases the transmission electric power by predetermined electric power (step S3). The predetermined electric power is, for example, 10% of the maximum transmission electric power.

Next, the main control unit 111 determines whether the transmission electric power is larger than a lower limit value (step S4). It is considered as to the power receiver 60 that various types of power receivers are used for charging and the like. The number of power receivers 60 is not limited to one, and a plurality of power receivers 60 may receive electric power at the same time.

For this reason, the lower limit value is set at a minimum amount of electric power for charging one typical power receiver. The minimum amount of electric power is, for example, a minimum amount of electric power that enables operation of a DC-DC converter of one power receiver (corresponding to the DC-DC converter 70 of the power receiver 60) and enables charging of a battery of the power receiver. The processing of step S4 by the main control unit 111 may be regarded as processing by a lower-limit determination unit.

When the main control unit 111 determines that the transmission electric power is larger than the lower limit value (S4: YES), the main control unit 111 is brought into a standby state for a standby time 2 (step S5). The standby time 2 is, for example, 50 milliseconds. The standby time 2 is set in step S5 for the purpose of waiting for stabilization of an impedance after the transmission electric power has been decreased in step S3.

Next, the charge state determination unit 113 monitors a change in impedance of the primary-side resonant coil 12 seen from the AC power supply 1 side, the impedance being detected by the impedance detection unit 13 (step S6). A monitoring time is, for example, 50 milliseconds.

Next, the charge state determination unit 113 determines whether the power receiver 60 does not perform the charging operation, based on the impedance detected by the impedance detection unit 13 (step S7). For example, the charge state determination unit 113 determines whether the power receiver 60 does not perform the charging operation, by determining whether the impedance detected by the impedance detection unit 13 does not fall within the certain predetermined range.

When the charge state determination unit 113 determines that the power receiver 60 performs the charging operation (S7: NO), the main control unit 111 returns the flow to step S2. A processing time for the first loop process including steps S2, S3, S5, S6, and S7 and returning the flow from step S7 to step S2 is about 100 milliseconds.

On the other hand, when the charge state determination unit 113 determines that the power receiver 60 does not perform the charging operation (S7: YES), the electric power control unit 112 increases the transmission electric power by the predetermined electric power (step S8). The electric power control unit 112 reads from the memory 115 a data item on transmission electric power at the time when the charge state determination unit 113 determined in the most recent control cycle in the past that the power receiver 60 performs the charging operation, and increases the transmission electric power to the transmission electric power in the read data item. For example, the transmission electric power is returned to latest (most recent) one of transmission electric power at the time when the charge state determination unit 113 determined in the past that the power receiver 60 performs the charging operation.

In executing the processing of step S8 for the first time after the turn-on of the power transmission apparatus 100, the memory 115 stores therein no data item on transmission electric power. In this case, the transmission electric power may be returned to a maximum value.

Next, the main control unit 111 is brought into a standby state for a standby time 2 (step S9). The standby time 2 is, for example, 50 milliseconds. The standby time 2 is set in step S9 for the purpose of waiting for stabilization of an impedance after the transmission electric power has been increased in step S8.

Next, the main control unit 111 resets a timer used for determining whether a processing time for the second loop process reaches the second required time (step S10). Such a timer is incorporated in the main control unit 111. The second required time is one minute (60 seconds).

Next, the charge state determination unit 113 monitors a change in impedance of the primary-side resonant coil 12 seen from the AC power supply 1 side, the impedance being detected by the impedance detection unit 13 (step S11).

Next, the charge state determination unit 113 determines whether the power receiver 60 does not perform the charging operation, based on the impedance detected by the impedance detection unit 13 (step S12). The processing of step S12 is similar to that of step S7. The processing of step S12 is an example of the second determination process.

When the charge state determination unit 113 determines that the power receiver 60 does not perform the charging operation (S12: YES), the electric power control unit 112 increases the transmission electric power by predetermined electric power (step S13). In the case where the power receiver 60 does not perform the charging operation, it is considered that the power transmission apparatus 100 is in a state incapable of supplying electric power for charging the battery 80 of the power receiver 60. For this reason, the electric power control unit 112 increases the transmission electric power.

The predetermined electric power in step S13 is 10% of the maximum transmission electric power. This value is equal to the predetermined electric power in step S3, but may be different from the predetermined electric power in step S3.

Next, the main control unit 111 is brought into a standby state for a standby time 2 (step S14). The standby time 2 is, for example, 50 milliseconds. The standby time 2 is set in step S14 for the purpose of waiting for stabilization of an impedance after the transmission electric power has been increased in step S13.

Next, the main control unit 111 determines whether the timer for counting the processing time for the second loop process reaches the second required time (step S15). The second required time is, for example, one minute (60 seconds).

When the main control unit 111 determines that the processing time for the second loop process does not reach the second required time (S15: NO), the main control unit 111 returns the flow to step S11. The second loop process is a loop process to be provided for increasing transmission electric power promptly in a case where the charge state determination unit 113 determines in the first loop process that the power receiver 60 does not perform the charging operation. In the case where the charge state determination unit 113 determines that power receiver 60 does not perform the charging operation, the transmission electric power is insufficient. Therefore, the transmission electric power is increased promptly to provide a state in which the power receiver 60 is capable of performing the charging operation.

In step S12, when the charge state determination unit 113 determines that the power receiver 60 performs the charging operation (S12: NO), the main control unit 111 causes the flow to proceed to step S14.

In the case where the power receiver 60 performs the charging operation, the power transmission apparatus 100 is in a state supplying electric power for charging the battery 80 of the power receiver 60. For this reason, the electric power control unit 112 does not need to execute the processing of increasing the transmission electric power in step S13.

In step S15, when the main control unit 111 determines that the processing time for the second loop process reaches the second required time (S15: YES), the main control unit 111 returns the flow to step S3.

In step S4, when the main control unit 111 determines that the transmission electric power is not larger than the lower limit value (S4: NO), the main control unit 111 stops the power transmission (step S16). The main control unit 111 temporarily stops the power transmission since the power transmission apparatus 100 is in a state not transmitting the minimum amount of electric power to the power receiver 60 for charging the battery 80. The main control unit 111 temporarily stops the power transmission since it may also be considered that the power receiver 60 is separated from the power transmission apparatus 100 after completion of the charging of the battery 80.

Next, the main control unit 111 causes the electric power control unit 112 to output a beacon signal (step S17). The beacon signal is a signal for searching for the power receiver 60, and is also a signal to be embodied by repeatedly outputting a pulse of transmission electric power.

Next, the main control unit 111 monitors a change in impedance of the primary-side resonant coil 12 seen from the AC power supply 1 side, the impedance being detected by the impedance detection unit 13 while causing the electric power control unit 112 to output the beacon signal, and determines whether the impedance changes (shifts) (step S18).

A state in which the power receiver 60 is out of a range capable of receiving electric power from the power transmission apparatus 100 and a state in which the power receiver 60 is within the range capable of receiving the electric power from the power transmission apparatus 100 are different from each other in an impedance of the primary-side resonant coil 12 seen from the AC power supply 1 side, the impedance being detected by the impedance detection unit 13, in the state in which the beacon signal is output. Therefore, the main control unit 111 monitors the change in impedance in the state in which the beacon signal is output, thereby detecting that the power receiver 60 enters the range capable of receiving the electric power from the power transmission apparatus 100.

When the main control unit 111 determines that the impedance changes (S18: YES), the main control unit 111 returns the flow to step S1. The main control unit 111 returns the flow to step S1 since the main control unit 111 starts power transmission.

On the other hand, when the main control unit 111 determines that the impedance does not change (S18: NO), the main control unit 111 returns the flow to step S17. As a result, a beacon signal is output successively.

The processes described above are executed repeatedly by the control unit 110 during the period from turn-on to turn-off of the power transmission apparatus 100.

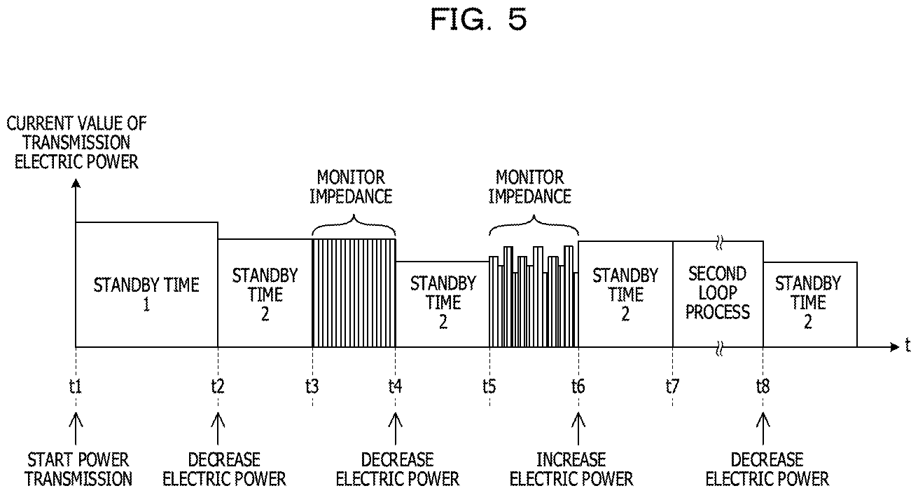

FIG. 5 is a diagram illustrating an exemplary operation of the power transmission apparatus 100 according to the first embodiment. In FIG. 5, the horizontal axis indicates a time (point in time), and the vertical axis indicates a current value to be detected by the impedance detection unit 13 of the power transmission apparatus 100. The current value to be detected by the impedance detection unit 13 is equivalent to a current value of transmission electric power to be output from the primary-side resonant coil 12 through the primary-side coil 11. Therefore, the vertical axis is treated as that indicating a current value of transmission electric power to be output from the primary-side resonant coil 12.

At a point in time t1, the electric power control unit 112 starts the power transmission, and the main control unit 111 is brought into the standby state for the standby time 1. This is an operation corresponding to the processing of steps S1 and S2.

At a point in time t2, the electric power control unit 112 decreases the transmission electric power by the predetermined electric power, and the main control unit 111 is brought into the standby state for the standby time 2. This is an operation corresponding to the processing of steps S3 and S5. When the electric power control unit 112 decreases the transmission electric power by the predetermined electric power at the point in time t2, then the main control unit 111 determines that the transmission electric power is larger than the lower limit value in the processing of step S4.

At a point in time t3, the charge state determination unit 113 determines whether the power receiver 60 performs the charging operation, based on the impedance detected by the impedance detection unit 13. This is an operation equivalent to the processing of steps S6 and S7. It is assumed herein that since the power receiver 60 performs the charging operation, the current value of the transmission electric power becomes substantially constant. The point in time t3 is a point in time elapsed from the point in time t2 by 50 milliseconds.

At a point in time t4, the electric power control unit 112 decreases the transmission electric power by the predetermined electric power, and the main control unit 111 is brought into the standby state for the standby time 2. This operation is an operation corresponding to the processing of steps S3 and S5 after the flow has been returned from step S7 to step S3 in the first loop process as the result of determination in the processing of step S7 that the power receiver 60 performs the charging operation.

At a point in time t5, the charge state determination unit 113 determines whether the power receiver 60 does not perform the charging operation, based on the impedance detected by the impedance detection unit 13. This is an operation equivalent to the processing of steps S6 and S7. It is assumed herein that since the power receiver 60 does not perform the charging operation, the current value of the transmission electric power fluctuates largely. The point in time t5 is a point in time elapsed from the point in time t4 by 50 milliseconds.

At a point in time t6, the electric power control unit 112 increases the transmission electric power to the transmission electric power stored in the memory 115, and the main control unit 111 is brought into the standby state for the standby time 2. This operation is an operation corresponding to the processing of steps S8 and S9 after the charge state determination unit 113 has determined in the processing of step S7 that the power receiver 60 does not perform the charging operation.

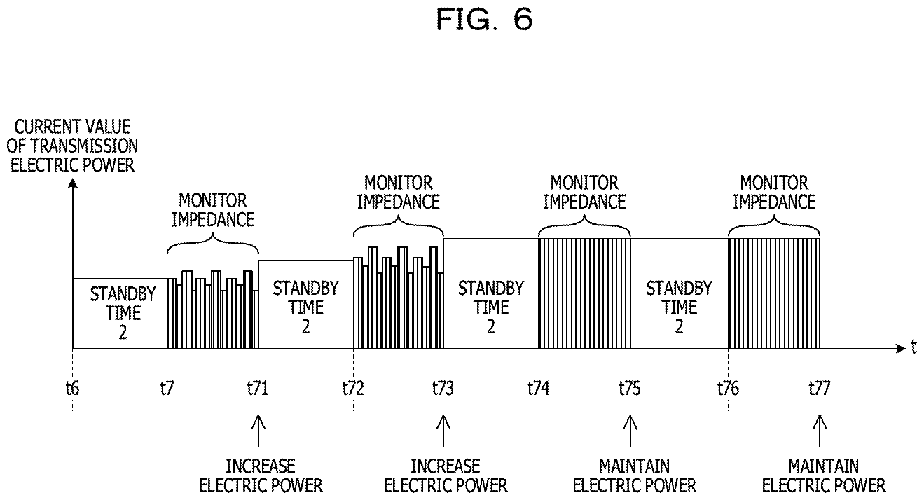

At a point in time t7, the control unit 110 executes the second loop process. Details of an exemplary operation in the second loop process will be described later with reference to FIG. 6. The current value of the transmission electric power output from the primary-side resonant coil 12 in the second loop process is variable in various patterns depending on the details of the second loop process. For convenience of the description, the current value of the transmission electric power in a period from the point in time t7 to a point in time t8 when the second loop process is executed is indicated by a fixed value.

At the point in time t8, the electric power control unit 112 decreases the transmission electric power by the predetermined electric power, and the main control unit 111 is brought into the standby state for the standby time 2. This operation is an operation corresponding to the processing of steps S3 and S5 after the second loop process has ended, and then the flow has been returned from step S15 to step S3.

After a lapse of the standby time 2 from the point in time t8, the control unit 110 executes the process in accordance with the flowchart of FIG. 5 depending on whether the power receiver 60 performs the charging operation at this time.

FIG. 6 is a diagram illustrating an exemplary operation of the power transmission apparatus 100 in the second loop process according to the first embodiment. The exemplary operation illustrated in FIG. 6 is a detailed exemplary operation in the period from the point in time t7 to the point in time t8 in FIG. 5.

At the point in time t7, the charge state determination unit 113 monitors the change in impedance detected by the impedance detection unit 13, and determines whether the power receiver 60 of the power receiver 60 does not perform the charging operation. This operation is an operation equivalent to steps S11 and S12. It is assumed herein that the power receiver 60 does not perform the charging operation, and the current value of the transmission electric power fluctuates largely.

At a point in time t71, the electric power control unit 112 increases the transmission electric power by the predetermined electric power, and the main control unit 111 is brought into the standby state for the standby time 2. This operation is an operation equivalent to steps S13 and S14.

At a point in time t72, the charge state determination unit 113 monitors the change in impedance detected by the impedance detection unit 13, and determines whether the power receiver 60 does not perform the charging operation. This operation is an operation equivalent to steps S11 and S12 in the case where the processing of steps S13 and S14 has terminated, and then the flow has been returned from step S15 to step S11. It is assumed herein that the power receiver 60 does not perform the charging operation, and the current value of the transmission electric power fluctuates largely.

At a point in time t73, the electric power control unit 112 increases the transmission electric power by the predetermined electric power, and the main control unit 111 is brought into the standby state for the standby time 2. This operation is an operation equivalent to steps S13 and S14.

At a point in time t74, the charge state determination unit 113 monitors the change in impedance detected by the impedance detection unit 13, and determines whether the power receiver 60 does not perform the charging operation. This operation is an operation equivalent to steps S11 and S12 in the case where the processing of steps S13 and S14 after the point in time t73 has terminated, and then the flow has been returned from step S15 to step S11. It is assumed herein that the power receiver 60 performs the charging operation, and the current value of the transmission electric power becomes substantially constant.

At a point in time t75, the main control unit 111 is brought into the standby state for the standby time 2. This operation is an operation equivalent to step S14 after the charge state determination unit 113 has determined in step S12 that the power receiver 60 performs the charging operation. Since the charge state determination unit 113 determines that the power receiver 60 performs the charging operation, the current value of the transmission electric power is maintained without being changed. The state in which the current value of the transmission electric power is maintained means a state in which the transmission electric power is maintained.

At a point in time t76, the charge state determination unit 113 monitors the change in impedance detected by the impedance detection unit 13, and determines whether the power receiver 60 does not perform the charging operation. This operation is an operation equivalent to steps S11 and S12 in the case where the processing of step S14 after the point in time t75 has terminated, and then the flow has been returned from step S15 to step S11. It is assumed herein that the power receiver 60 performs the charging operation, and the current value of the transmission electric power becomes substantially constant.

At a point in time t77, the main control unit 111 is brought into the standby state for the standby time 2 (this operation is not illustrated in FIG. 6). This operation is an operation equivalent to step S14 after the charge state determination unit 113 has determined in step S12 that the power receiver 60 performs the charging operation. Since the charge state determination unit 113 determines that the power receiver 60 performs the charging operation, the current value of the transmission electric power is maintained without being changed.

Thereafter, the second loop process is executed until the main control unit 111 determines in step S15 that the processing time for the second loop process reaches the second required time. When the second loop process ends, the flow is returned to step S3 in which the transmission electric power is decreased by the predetermined electric power. This is equivalent to the point in time t8 in FIG. 5.

As described above, the power transmission apparatus 100 executes the first loop process and second loop process illustrated in FIGS. 5 and 6, thereby adjusting the transmission electric power in accordance with the change in impedance of the power receiver 60.

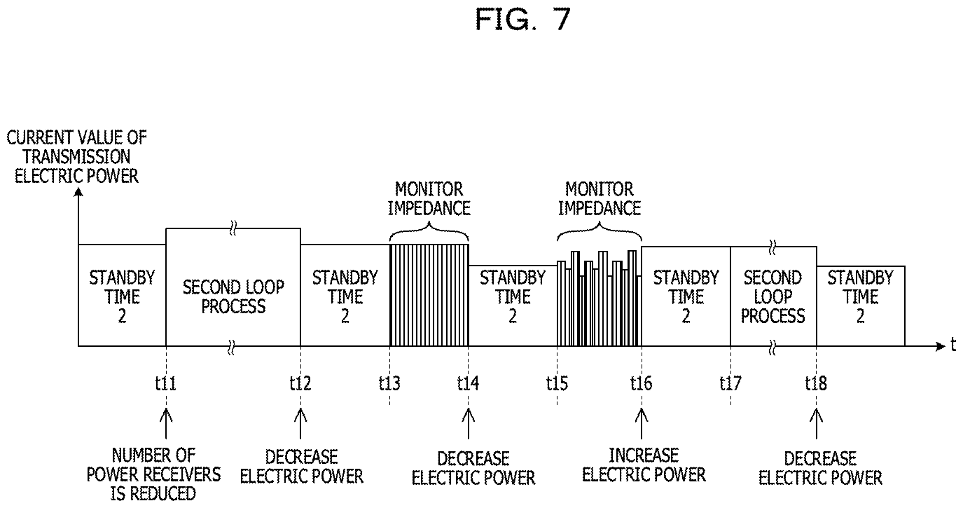

FIG. 7 is a diagram illustrating another exemplary operation of the power transmission apparatus 100 according to the first embodiment. In FIG. 7, the horizontal axis indicates a time (point in time), and the vertical axis indicates a current value to be detected by the impedance detection unit 13 of the power transmission apparatus 100 (a current value of transmission electric power to be output from the primary-side resonant coil 12).

It is assumed that at a point in time t11, the number of power receivers 60 that receive electric power from the power transmission apparatus 100 is reduced by one, and the control unit 110 executes the second loop process. The current value of the transmission electric power output from the primary-side resonant coil 12 in the second loop process is variable in various patterns depending on the details of the second loop process. For convenience of the description, the current value of the transmission electric power in a period from the point in time t11 to a point in time t12 when the second loop process is executed is indicated by a fixed value. The period from the point in time t11 to the point in time t12 is a second processing time (one minute).

At the point in time t12, the electric power control unit 112 decreases the transmission electric power by the predetermined electric power, and the main control unit 111 is brought into the standby state for the standby time 2. This is an operation corresponding to the processing of steps S3 and S5. When the electric power control unit 112 decreases the transmission electric power by the predetermined electric power at the point in time t12, then the main control unit 111 determines that the transmission electric power is larger than the lower limit value in the processing of step S4.

At a point in time t13, the charge state determination unit 113 determines whether the power receiver 60 performs the charging operation, based on the impedance detected by the impedance detection unit 13. This is an operation equivalent to the processing of steps S6 and S7. It is assumed herein that since the power receiver 60 performs the charging operation, the current value of the transmission electric power becomes substantially constant. The point in time t13 is a point in time elapsed from the point in time t12 by 50 milliseconds.

At the point in time t14, the electric power control unit 112 decreases the transmission electric power by the predetermined electric power, and the main control unit 111 is brought into the standby state for the standby time 2. This operation is an operation corresponding to the processing of steps S3 and S5 after the flow has been returned from step S7 to step S3 in the first loop process as the result of determination in the processing of step S7 that the power receiver 60 performs the charging operation.

At a point in time t15, the charge state determination unit 113 determines whether the power receiver 60 does not perform the charging operation, based on the impedance detected by the impedance detection unit 13. This is an operation equivalent to the processing of steps S6 and S7. It is assumed herein that since the power receiver 60 does not perform the charging operation, the current value of the transmission electric power fluctuates largely. The point in time t15 is a point in time elapsed from the point in time t14 by 50 milliseconds.

At a point in time t16, the electric power control unit 112 increases the transmission electric power to the transmission electric power stored in the memory 115, and the main control unit 111 is brought into the standby state for the standby time 2. This operation is an operation corresponding to the processing of steps S8 and S9 after the charge state determination unit 113 has determined in the processing of step S7 that the power receiver 60 does not perform the charging operation.

At a point in time t17, the control unit 110 executes the second loop process. The details of the second loop process are as illustrated in, for example, FIG. 6. The current value of the transmission electric power output from the primary-side resonant coil 12 in the second loop process is variable in various patterns depending on the details of the second loop process. For convenience of the description, the current value of the transmission electric power in a period from the point in time t17 to a point in time t18 when the second loop process is executed is indicated by a fixed value.

At the point in time t18, the electric power control unit 112 decreases the transmission electric power by the predetermined electric power, and the main control unit 111 is brought into the standby state for the standby time 2. This operation is an operation corresponding to the processing of steps S3 and S5 after the second loop process has ended, and then the flow has been returned from step S15 to step S3.

After a lapse of the standby time 2 from the point in time t18, the control unit 110 executes the process in accordance with the flowchart of FIG. 7 depending on whether the power receiver 60 performs the charging operation at this time.

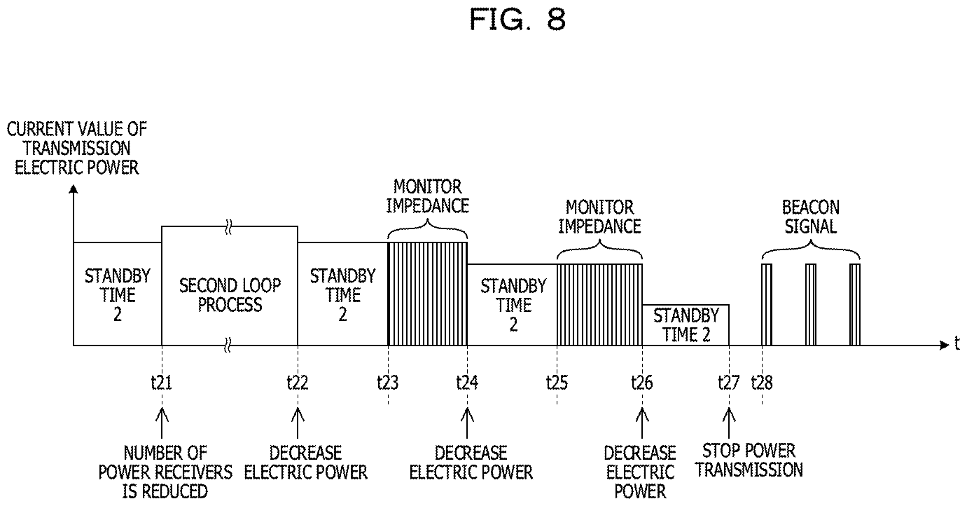

FIG. 8 is a diagram illustrating still another exemplary operation of the power transmission apparatus 100 according to the first embodiment. In FIG. 8, the horizontal axis indicates a time (point in time), and the vertical axis indicates a current value to be detected by the impedance detection unit 13 of the power transmission apparatus 100 (a current value of transmission electric power to be output from the primary-side resonant coil 12).

It is assumed that at a point in time t21, the number of power receivers 60 that receive electric power from the power transmission apparatus 100 is reduced by one, and the control unit 110 executes the second loop process. The current value of the transmission electric power output from the primary-side resonant coil 12 in the second loop process is variable in various patterns depending on the details of the second loop process. For convenience of the description, the current value of the transmission electric power in a period from the point in time t21 to a point in time t22 when the second loop process is executed is indicated by a fixed value. The period from the point in time t21 to the point in time t22 is a second processing time (one minute).

At the point in time t22, the electric power control unit 112 decreases the transmission electric power by the predetermined electric power, and the main control unit 111 is brought into the standby state for the standby time 2. This is an operation corresponding to the processing of steps S3 and S5. When the electric power control unit 112 decreases the transmission electric power by the predetermined electric power at the point in time t22, then the main control unit 111 determines that the transmission electric power is larger than the lower limit value in the processing of step S4.

At a point in time t23, the charge state determination unit 113 determines whether the power receiver 60 performs the charging operation, based on the impedance detected by the impedance detection unit 13. This is an operation equivalent to the processing of steps S6 and S7. It is assumed herein that since the power receiver 60 performs the charging operation, the current value of the transmission electric power becomes substantially constant. The point in time t23 is a point in time elapsed from the point in time t22 by 50 milliseconds.

At the point in time t24, the electric power control unit 112 decreases the transmission electric power by the predetermined electric power, and the main control unit 111 is brought into the standby state for the standby time 2. This operation is an operation corresponding to the processing of steps S3 and S5 after the flow has been returned from step S7 to step S3 in the first loop process as the result of determination in the processing of step S7 that the power receiver 60 performs the charging operation.

At a point in time t25, the charge state determination unit 113 determines whether the power receiver 60 does not perform the charging operation, based on the impedance detected by the impedance detection unit 13. This is an operation equivalent to the processing of steps S6 and S7. It is assumed herein that since the power receiver 60 performs the charging operation, the current value of the transmission electric power becomes stable. The point in time t25 is a point in time elapsed from the point in time t24 by 50 milliseconds.

At the point in time t26, the electric power control unit 112 decreases the transmission electric power by the predetermined electric power, and the main control unit 111 is brought into the standby state for the standby time 2. This operation is an operation corresponding to the processing of steps S3 and S5 after the second loop process has ended, and then the flow has been returned from step S15 to step S3.

At a point in time t27, the main control unit 111 determines that the transmission electric power is not larger than the lower limit value, and stops the power transmission. This is the case where the flow has proceeded from step S4 to step S16.

At a point in time t28, the main control unit 111 monitors the change in impedance of the primary-side resonant coil 12 seen from the AC power supply 1 side, the impedance being detected by the impedance detection unit 13 while causing the electric power control unit 112 to output the beacon signal, and determines whether the impedance changes (shifts). This is equivalent to the processing of steps S17 and S18.

Thereafter, when the impedance changes, the power transmission is started. This is equivalent to the processing of steps S18 and S1.

As described above, according to the first embodiment, provided is the power transmission apparatus 100 capable of determining whether the power receiver 60 performs the charging operation, in accordance with the change in impedance of the power receiver 60, without acquiring, from the power receiver 60, a capacity of the battery 80 of the power receiver 60, a rated output for charging the battery 80, information as to whether the power receiver 60 charges the battery 80, and others, and adjusting the transmission electric power in accordance with a result of the determination.

The power transmission apparatus 100 is capable of adjusting the transmission electric power solely without wireless communication. Therefore, provided is the power transmission apparatus 100 having the simple configuration.

The second loop process ends in the case where the second required time (one minute) has elapsed in step S15; therefore, the transmission electric power is not decreased for one minute. In the case where the second loop process is executed without a lapse of the second required time, the transmission electric power is increased in about 100 milliseconds.

For example, in the case where the transmission electric power is insufficient, the transmission electric power is quickly increased at an interval of 100 milliseconds. The transmission electric power is then decreased after the lapse of the second required time (one minute) in step S15. Therefore, the decrease of the transmission electric power is performed at a slower pace than the increase of the transmission electric power.

This is because a chargeable state is quickly provided in any case. Even when the transmission electric power is excessive, the power receiver 60 performs the charging operation. Therefore, the chargeable state is preferentially provided. For this reason, preferably, the second required time (one minute) until the second loop process ends is made satisfactorily longer than a time (about 100 milliseconds) required for executing the second loop process once.

In the foregoing description, the DC-DC converter 70 is a step-down DC-DC converter. Alternatively, the DC-DC converter 70 may be a step-up DC-DC converter.

Also in the foregoing description, the impedance detection unit 13 detects a current of transmission electric power supplied from the AC power supply 1 to the primary-side coil 11, thereby detecting an impedance of the primary-side resonant coil 12 seen from the AC power supply 1 side. Alternatively, the impedance detection unit 13 may detect a voltage of the transmission electric power supplied from the AC power supply 1 to the primary-side coil 11, thereby detecting the impedance of the primary-side resonant coil 12 seen from the AC power supply 1 side. The voltage of the transmission electric power is a voltage across the two terminals of the primary-side coil 11.

Also in the foregoing description, the power transmitter 10 includes the primary-side coil 11 and the primary-side resonant coil 12. However, the power transmitter 10 does not necessarily include the primary-side coil 11. For example, the primary-side resonant coil 12 may be directly connected to the impedance detection unit 13.

### Second Embodiment

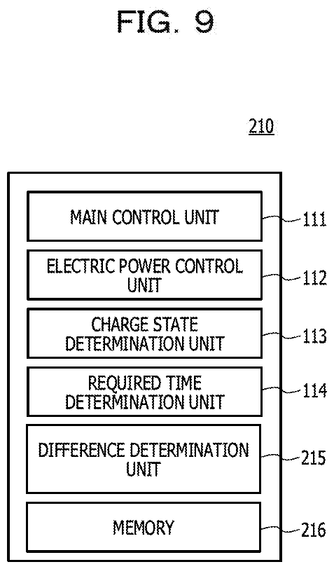

FIG. 9 is a diagram illustrating a control unit 210 of a power transmission apparatus according to a second embodiment. The power transmission apparatus according to the second embodiment includes the control unit 210 in place of the control unit 110 of the power transmission apparatus 100 according to the first embodiment.

The control unit 210 includes a main control unit 111, an electric power control unit 112, a charge state determination unit 113, a required time determination unit 114, a difference determination unit 215, and a memory 216.

When the charge state determination unit 113 determines in the second determination process (step S12) that the power receiver 60 performs the charging operation, the difference determination unit 215 determines whether a difference between an impedance at the time when the charge state determination unit 113 determines that the power receiver 60 performs the charging operation and an impedance held by the memory 216 is equal to or less than a predetermined value.

The memory 216 stores therein: a data item on transmission electric power at the time when the charge state determination unit 113 determines that the power receiver 60 performs the charging operation; a data item on an impedance used for determination at the time when the charge state determination unit 113 determines that the power receiver 60 performs the charging operation; and a data item on the predetermined value used for the determination process as to the difference between the impedances.

The impedance used for determination at the time when the charge state determination unit 113 determines that the power receiver 60 performs the charging operation is used for processing of step S21, and is overwritten in the memory 216 in processing of step S23 as will be described later.

The memory 216 stores therein only one impedance value used for determination at the time when the charge state determination unit 113 determines that the power receiver 60 performs the charging operation. The impedance value is overwritten each time the processing of step S23 is repeated. In executing the processing of step S21 for the first time, the memory 216 stores therein no impedance value. Therefore, the memory 216 stores therein an initial impedance value in order to execute the processing of step S21 for the first time. The initial impedance value is overwritten in the processing of step S23.

As to a data item on transmission electric power, when the charge state determination unit 113 determines that the power receiver 60 performs the charging operation, the memory 216 stores therein only a data item on transmission electric power at this time. Therefore, a data item on transmission electric power stored in the memory 216 is only a data item on latest transmission electric power among data items on transmission electric power at the time when the charge state determination unit 113 determined in the past that the power receiver 60 performs the charging operation. The memory 216 stores therein only one data item on transmission electric power.

As to a data item on an impedance value, when the charge state determination unit 113 determines that the power receiver 60 performs the charging operation, the memory 216 stores therein only a data item on an impedance value at this time. Therefore, a data item on an impedance value stored in the memory 216 is only a data item on a latest impedance value among data items on impedance values at the time when the charge state determination unit 113 determined in the past that the power receiver 60 performs the charging operation. The memory 216 stores therein only one data item on an impedance value.

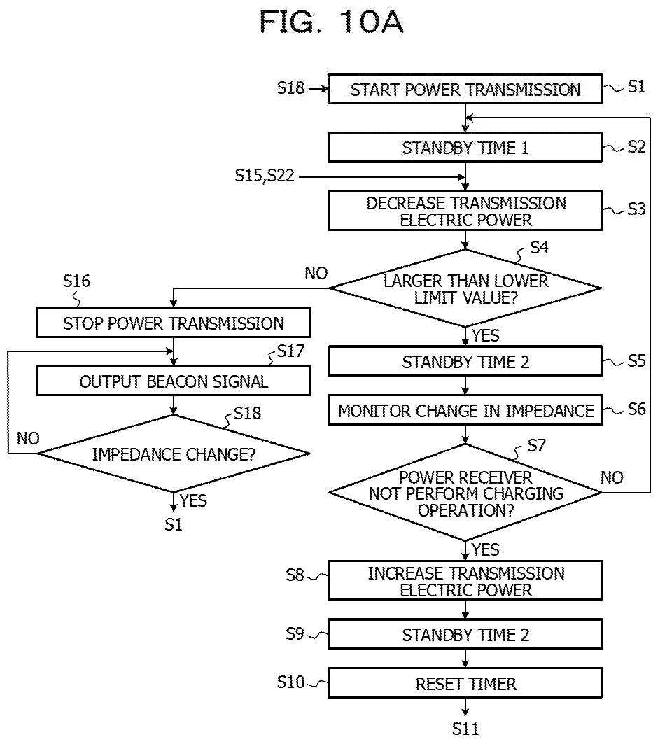

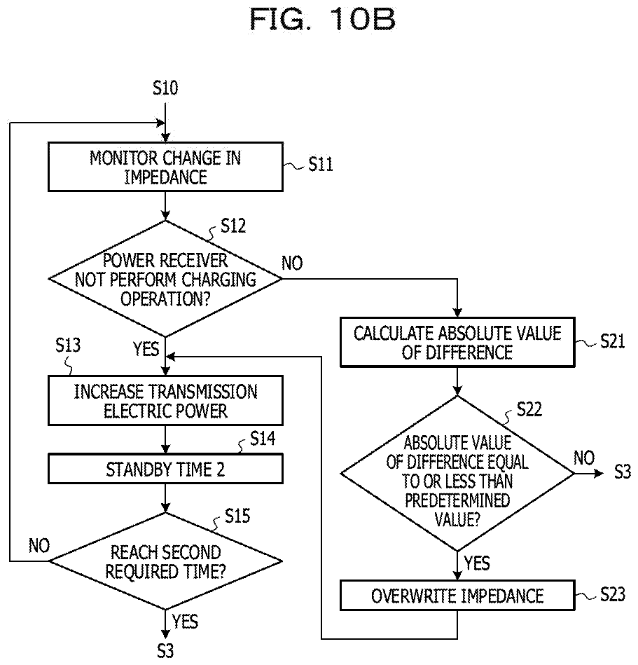

FIGS. 10A and 10B are a flowchart illustrating processes to be executed by the control unit 210 according to the second embodiment. In the flowchart of FIGS. 10A and 10B, steps S1 to S18 are similar to steps S1 to S18 of the flowchart illustrating the processes executed by the control unit 210 according to the first embodiment in FIG. 4. Therefore, a description will be given of steps S21 to S23, that is, a difference between the second embodiment and the first embodiment. Steps S21 to S23 are included in a second loop process according to the second embodiment.

In step S12, when the charge state determination unit 113 determines that the power receiver 60 performs the charging operation (S12: NO), the difference determination unit 215 calculates an absolute value of the difference between the impedance at the time when the charge state determination unit 113 determines that the power receiver 60 performs the charging operation and the impedance held by the memory 216 (step S21).

The difference determination unit 215 determines whether the absolute value of the difference is equal to or less than the predetermined value (step S22). Since the data item on the predetermined value is stored in the memory 216, the difference determination unit 215 reads the data item in the determination process of step S22.

When the difference determination unit 215 determines that the difference is equal to or less than the predetermined value (S22: YES), the difference determination unit 215 overwrites, into the memory 216, the data item on the impedance at the time when the charge state determination unit 113 determines that the power receiver 60 performs the charging operation (step S23). The processing of step S23 is a holding process in which the difference determination unit 215 causes the memory 216 to hold the impedance.

When the processing of step S23 terminates, the main control unit 111 causes the flow to proceed to step S14.

When the difference determination unit 215 determines that the difference is not equal to or less than the predetermined value (S22: NO), the main control unit 111 returns the flow to step S2. In the case where the difference between the impedances is larger than the predetermined value, there is a high possibility that the number of power receivers 60 changes; therefore, the transmission electric power is decreased in step S2.

It is assumed herein that the case where the number of power receivers 60 changes is a case where a plurality of power receivers 60 perform a charging operation, and at least one of the plurality of power receivers 60 deviates from a power receivable range. For example, it is assumed herein that the number of power receivers 60 is reduced.

For example, in a state in which three power receivers 60 are charged, when one of the power receivers 60 deviates from the power receivable range, and the two power receivers 60 remain the power receivable range, the charge state determination unit 113 determines in step S12 that the power receivers 60 perform the charging operation as long as the two power receivers 60 are charged successively.

In the second embodiment, therefore, the difference determination unit 215 determines in the processing of step S22 whether the difference between the impedances is equal to or less than the predetermined value, so that the difference determination unit 215 determines whether the number of power receivers 60 is reduced. The predetermined value used in step S22 may be set at a value to a degree capable of determining that the number of power receivers 60 is reduced.

In the case where the number of power receivers 60 is reduced, the flow is returned to step S2 in order to decrease the transmission electric power in accordance with the reduction in number of power receivers 60.

As described above, according to the second embodiment, as in the first embodiment, provided is the power transmission apparatus capable of determining whether the power receiver 60 performs the charging operation, in accordance with the change in impedance of the power receiver 60, without acquiring, from the power receiver 60, a capacity of the battery 80 of the power receiver 60, a rated output for charging the battery 80, information as to whether the power receiver 60 charges the battery 80, and others, and adjusting the transmission electric power in accordance with a result of the determination.

The power transmission apparatus according to the second embodiment is capable of adjusting the transmission electric power solely without wireless communication. Therefore, provided is the power transmission apparatus having the simple configuration.

In the second embodiment, the reduction in number of power receivers 60 is determined in the processing of step S22. Therefore, when the number of power receivers 60 is reduced, the transmission electric power is decreased in step S2. Thus, efficient power transmission is effected in accordance with the number of power receivers 60.

Since the latest impedance value is stored in the memory 216 in step S23, the determination process in step S22 is executed using the latest (most recent) impedance value in the next control cycle.

Although a power transmission apparatus, an electric power transmission system, and a method for controlling the power transmission apparatus according to exemplary embodiments of the present invention have been described in detail, it should be understood that the present invention is not limited to the embodiments disclosed in detail, and the various changes and alterations could be made hereto without departing from the spirit and scope of the invention.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A power transmission apparatus for transmitting electric power to one or more power receivers each including a secondary-side resonant coil, the power transmission apparatus comprising:
a primary-side resonant coil configured to transmit electric power by magnetic field resonance or electric field resonance;
a high-frequency power supply configured to output transmission electric power with high-frequency to the primary-side resonant coil; and
a processor configured to control the transmission electric power output from the high-frequency power supply to the primary-side resonant coil and determine whether the one or more power receivers perform a charging operation, based on an impedance of the primary-side resonant coil which is seen from the high-frequency power supply side,
wherein the electronic power controller is configured to execute a first loop process to be executed after starting power transmission by predetermined transmission electric power, the first loop process includes:
a first transmission electric power control process in which the processor decreases the transmission electric power output from the high-frequency power supply by the predetermined electric power; and
a first determination process in which the processor determines whether the one or more power receivers perform the charging operation, in a state in which the transmission electric power decreased by the predetermined electric power is transmitted, and
the first loop process returns to the first transmission electric power control process by the processor when determining in the first determination process that the one or more power receivers perform the charging operation.

2. The power transmission apparatus according to claim 1, wherein
the processor is configured to execute a second transmission electric power control process in which when determining that the one or more power receivers do not perform the charging operation, the processor increases the transmission electric power output from the high-frequency power supply, to a transmission electric power at the time when determining that the one or more power receivers perform the charging operation.

3. The power transmission apparatus according to claim 2, wherein
the processor is configured to:
determine whether a time for a second loop process to be executed after execution of the second transmission electric power control process is equal to or more than a second time that is longer than a first time for the first loop process;
execute the second loop process including:
a second determination process in which whether the one or more power receivers perform the charging operation is determined;
a third transmission electric power control process in which the processor increases the transmission electric power output from the high-frequency power supply when determining in the second determination process that the one or more power receivers do not perform the charging operation; and
a time determination process in which whether the time for the second loop process is equal to or more than the second time is determined after the processor increases the transmission electric power in the third transmission electric power control process; and
return the second loop process to the second determination process when determining in the time determination process that the time for the second loop process is not equal to or more than the second time.

4. The power transmission apparatus according to claim 3, wherein
in the second loop process, when determining in the second determination process that the one or more power receivers perform the charging operation, the processor does not execute the third transmission electric power control process, and executes the time determination process.

5. The power transmission apparatus according to claim 4, further comprising:
a memory configured to store an impedance value which is used for determination at the time when the processor determines in the second determination process that the one or more power receivers perform the charging operation,
wherein the processor is configured to:
determine, when determining in the second determination process that the one or more power receivers perform the charging operation, whether a difference between the impedance which is used for determination at the time when determining that the one or more power receivers perform the charging operation and the impedance stored in the memory in the second loop process before one cycle or more is equal to or less than a predetermined value; and
execute, in the second loop process, a holding process of causing the memory to store the impedance used for determination at the time when determining that the one or more power receivers perform the charging operation, when determining in the second determination process that the one or more power receivers perform the charging operation and determining that the difference is equal to or less than the predetermined value.

6. The power transmission apparatus according to claim 5, wherein
when determining in the second determination process that the one or more power receivers perform the charging operation and determining that the difference is not equal to or less than the predetermined value, the processor is configured to: terminate the second loop process; and execute the first transmission electric power control process in which the processor decreases the transmission electric power by the predetermined electric power in the first loop process.

7. The power transmission apparatus according to claim 1, wherein
the first loop process further includes a lower-limit determination process of determining whether the transmission electric power decreased in the first transmission electric power control process is equal to or less than a predetermined lower limit value after execution of the first transmission electric power control process and before execution of the first determination process, and
the first determination process is executed when it is determined in the lower-limit determination process that the transmission electric power is not equal to or less than the predetermined lower limit value.

8. The power transmission apparatus according to claim 7, wherein
when it is determined in the lower-limit determination process that the transmission electric power is equal to or less than the predetermined lower limit value, the processor is configured to end the first loop process, and execute a search process of causing the high-frequency power supply to output a pulse of high-frequency electric power, as a beacon signal for searching for the one or more power receivers.

9. The power transmission apparatus according to claim 1, wherein
the processor is configured to determine whether the one or more power receivers perform the charging operation, based on, as the impedance of the primary-side resonant coil which is seen from the high-frequency power supply side, an impedance obtained from a current value or voltage value of the transmission electric power output from the high-frequency power supply to the primary-side resonant coil.

10. The power transmission apparatus according to claim 1, wherein
the predetermined transmission electric power at the time when starting the power transmission is maximum transmission electric power of the power transmission apparatus.

11. The power transmission apparatus according to claim 1, wherein
the predetermined transmission electric power at the time when starting the power transmission is transmission electric power higher than minimum transmission electric power of the power transmission apparatus.

12. An electric power transmission system comprising:
one or more power receivers each including a secondary-side resonant coil; and
a power transmission apparatus configured to transmit electric power to the one or more power receivers by magnetic field resonance or electric field resonance,
wherein
the power transmission apparatus includes:
a primary-side resonant coil configured to transmit electric power by magnetic field resonance or electric field resonance;
a high-frequency power supply configured to output transmission electric power with high-frequency to the primary-side resonant coil; and
a processor configured to:
control the transmission electric power output from the high-frequency power supply to the primary-side resonant coil;
determine whether the one or more power receivers perform a charging operation, based on an impedance of the primary-side resonant coil which is seen from the high-frequency power supply side;
execute a first loop process to be executed after starting power transmission by predetermined transmission electric power, the first loop process including: a first transmission electric power control process in which the processor decreases transmission electric power output from the high-frequency power supply by the predetermined electric power and a first determination process in which the processor determines whether the one or more power receivers perform the charging operation, in a state in which the transmission electric power decreased by the predetermined electric power is transmitted; and
return the first loop process to the first transmission electric power control process when determining in the first determination process that the one or more power receivers perform the charging operation.

13. A method for controlling a power transmission apparatus configured to transmit electric power to one or more power receivers each including a secondary-side resonant coil, the method comprising:
controlling, by a processor, transmission electric power with high-frequency output from a high-frequency power supply to a primary-side resonant coil which is configured to transmit electric power by magnetic field resonance or electric field resonance;
determining whether the one or more power receivers perform a charging operation, based on an impedance of the primary-side resonant coil which is seen from the high-frequency power supply side;
executing a first loop process to be executed after starting power transmission by predetermined transmission electric power, the first loop process including: a first transmission electric power control process in which the processor decreases transmission electric power output from the high-frequency power supply by the predetermined electric power; and a first determination process in which the processor determines whether the one or more power receivers perform the charging operation, in a state in which the transmission electric power decreased by the predetermined electric power is transmitted; and
returning to the first transmission electric power control process when determining in the first determination process that the one or more power receivers perform the charging operation.
